(19) United States
(12) Patent Application Publication
(10) Pub. No.: US 2018/0266496 A1
(43) Pub. Date: Sep. 20, 2018

(54) POWER TRANSMISSION SYSTEM

(71) Applicant: HONDA MOTOR CO., LTD., Tokyo (JP)

(72) Inventors: Sachi FUJINUMA, Wako (JP); Sota TANAKA, Wako (JP)

(73) Assignee: HONDA MOTOR CO., LTD., Tokyo (JP)

(21) Appl. No.: 15/891,368

(22) Filed: Feb. 8, 2018

(30) Foreign Application Priority Data
Mar. 15, 2017 (JP) 2017-050469

(51) Int. Cl. F16D 25/0638; F16D 13/52; F16D 13/02; F16F 1/04

(52) U.S. Cl. CPC F16D 25/0638; F16D 13/52; F16D 13/025; F16F 2234/02; F16F 2238/026; F16F 2232/08; F16F 1/048

(57) ABSTRACT

A power transmission system includes a rotating shaft, a power transmission component, a pressing member, and a wave spring. The rotating shaft is rotatable about a rotating axis. The power transmission component includes a frictional engagement portion that includes a plurality of friction members alternately stacked in an axial direction along the rotating axis. The pressing member has a contact portion and is disposed to be movable in the axial direction to press the frictional engagement portion such that the plurality of friction members engage with each other. The wave spring is to press the pressing member at the contact portion in the axial direction away from the frictional engagement portion. The contact portion of the pressing member has a reduced friction between the contact portion and the wave spring along a circumference of the wave spring.

### CROSS-REFERENCE TO RELATED APPLICATIONS

The present application claims priority under 35 U.S.C. § 119 to Japanese Patent Application No. 2017-050469, filed Mar. 15, 2017, entitled “Power Transmission System.” The contents of this application are incorporated herein by reference in their entirety.

### BACKGROUND

### 1. Field

The present disclosure relates to a power transmission system.

### 2. Description of the Related Art

As in the example described in Japanese Patent Application Publication No. 2016-142375, examples of automobile power transmission systems include a power transmission system that includes a clutch or a brake mounted on the outer circumference of a rotating shaft. The power transmission system described in Japanese Patent Application Publication No. 2016-142375 includes a clutch capable of switching between transmitting or stopping transmitting rotation between two rotating shafts coaxially arranged. The clutch includes a clutch housing fixed to one of the rotating shafts, and a clutch hub fixed to the other rotating shaft on the inner periphery of the clutch housing. The clutch also includes a frictional engagement portion in the clutch housing. The frictional engagement portion includes multiple friction members fixed to the clutch housing and multiple friction members fixed to the clutch hub, which are alternately stacked in the axial direction.

The power transmission system includes a piston member, which presses the frictional engagement portion in the direction in which the friction members are stacked, a piston housing, which houses the piston member, and a piston chamber, which is defined by the piston member in the piston housing and in which a hydraulic pressure that drives the piston member toward the power transmission components is produced. The clutch engages, when the piston member is driven by the hydraulic pressure produced in the piston chamber to press and cause the frictional engagement portion to engage.

The above power transmission system including a clutch mounted on the outer periphery of the rotating shaft includes a return spring between the piston member and a spring guide on the clutch housing to urge the piston member with the elastic force of the return spring. Instead of using a coil spring including multiple coiled springs disposed on an annular plate, using a plate-shaped wave spring having a wavily bent surface as an example of the return spring is advantageous in, for example, the reduction of the number of components.

A wave spring is formed by winding a wavily bent linear plate. To wind the linear plate multiple times for multiple bends to be superposed on each other in the axial direction, adjacent wavy mountain and valley bends are superposed on each other in the axial direction. Aligning the angular positions of the adjacent wavy mountain and valley bends in this manner enhances the elastic force.

### SUMMARY

According to one aspect of the present invention, a power transmission system includes a rotating shaft, a power transmission component including a frictional engagement portion formed by alternately stacking multiple friction members in the axial direction at the outer circumference of the rotating shaft, a pressing member disposed to be movable in the axial direction and pressing the frictional engagement portion to engage the multiple friction members to each other, and an urging member that urges the pressing member in a direction away from the frictional engagement portion. The urging member is a wave spring formed with multiple windings. A contact portion of the pressing member with which the wave spring comes into contact is processed so as to reduce the friction in the circumferential direction of the wave spring.

According to another aspect of the present invention, a power transmission system includes a rotating shaft, a power transmission component, a pressing member, and a wave spring. The rotating shaft is rotatable about a rotating axis. The power transmission component includes a frictional engagement portion that includes a plurality of friction members alternately stacked in an axial direction along the rotating axis. The pressing member has a contact portion and is disposed to be movable in the axial direction to press the frictional engagement portion such that the plurality of friction members engage with each other. The wave spring is to press the pressing member at the contact portion in the axial direction away from the frictional engagement portion. The contact portion of the pressing member has a reduced friction between the contact portion and the wave spring along a circumference of the wave spring.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a sectional view of a power transmission system according to an embodiment, viewed sideways.

FIG. 2 is a partially enlarged sectional view of a detailed structure of a clutch and its surroundings (portion II in FIG. 1).

FIG. 3 is an exploded perspective view of a piston housing, a cylinder piston, a wave spring, and a spring guide.

FIGS. 4A and 4B illustrate a wave spring, where FIG. 4A is a perspective view of the wave spring, and FIG. 4B is a side view of the wave spring, viewed in direction IVB in FIG. 4A.

### DESCRIPTION OF THE EMBODIMENTS

The embodiments will now be described with reference to the accompanying drawings, wherein like reference numerals designate corresponding or identical elements throughout the various drawings.

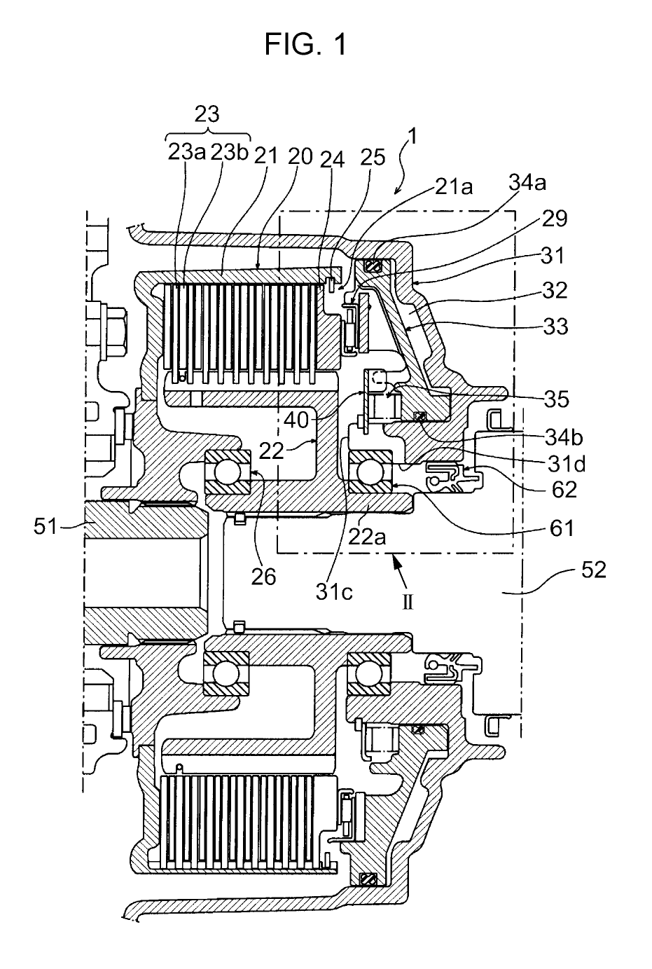

Embodiments are described below in detail with reference to the drawings. FIG. 1 is a sectional view of a power transmission system 1 according to an embodiment. The power transmission system 1 illustrated in FIG. 1 includes a clutch that distributes a driving force to the left and right wheels of a vehicle. The power transmission system 1 includes a first rotating shaft 51, to which a driving force is transmitted from a driving source, a second rotating shaft 52, arranged coaxially with the first rotating shaft 51, and a clutch 20, which couples the first rotating shaft 51 and the second rotating shaft 52 with each other by appropriately engaging or disengaging the shafts. Here, the first rotating shaft 51 is a rotation input shaft extending in the vehicle axis direction between the left and right driving wheels. The second rotating shaft 52 is a right vehicle shaft continuous with the right driving wheel of the vehicle. The clutch 20 is a right clutch for controlling the distribution of the driving force transmitted from the rotation input shaft to the right vehicle shaft.

The clutch 20 includes a substantially cylindrical clutch housing 21, coupled to an end portion of the first rotating shaft 51, a clutch hub 22, coupled to, using a spline, an end portion of the second rotating shaft 52 at the inner periphery of the clutch housing 21, and pressure plates 23a and friction plates 23b, which are friction members alternately stacked in the axial direction inside the clutch housing 21.

Each pressure plate 23a is engaged with the clutch housing 21 using a spline at its outer periphery. Each friction plate 23b is engaged with the clutch hub 22 using a spline at its inner periphery. These pressure plates 23a and friction plates 23b constitute a frictional engagement portion 23.

At one end (facing the cylinder piston 33) in the direction in which the pressure plates 23a and the friction plates 23b are stacked, an end plate 24 is disposed. The clutch housing 21 includes, at the end (facing the cylinder piston 33) in the axial direction, an opening 21a, at which a circlip 25 is disposed to prevent unintended pullout of the end plate 24. In a space between the clutch housing 21 and the clutch hub 22 on the inner side of the frictional engagement portion 23 in the radial direction, a clutch bearing 26 is disposed to support the clutch housing 21 and the clutch hub 22 while allowing the clutch housing 21 and the clutch hub 22 to rotate relative to each other.

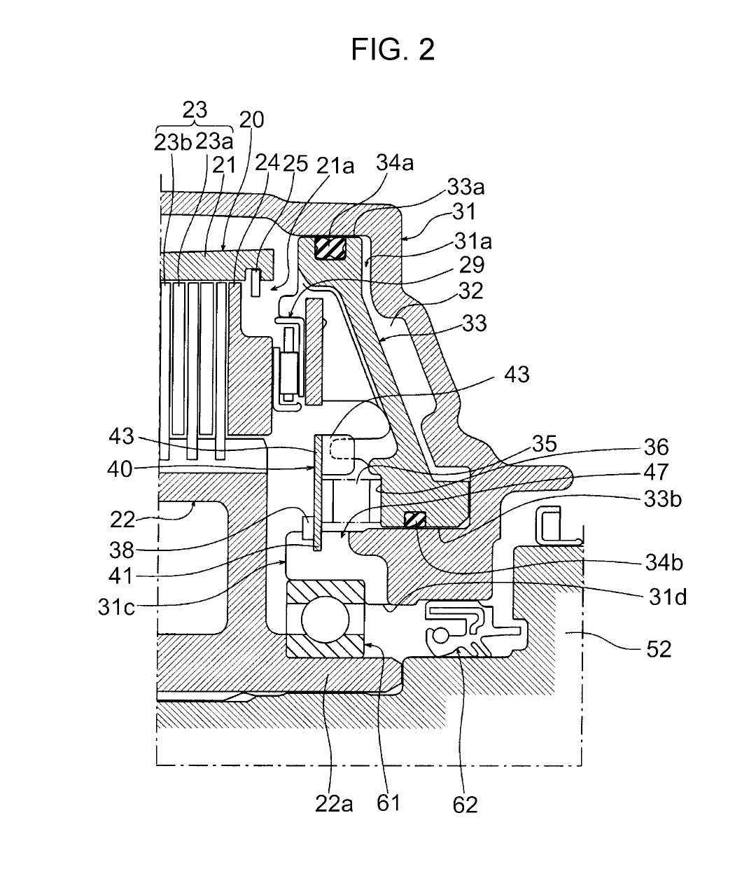

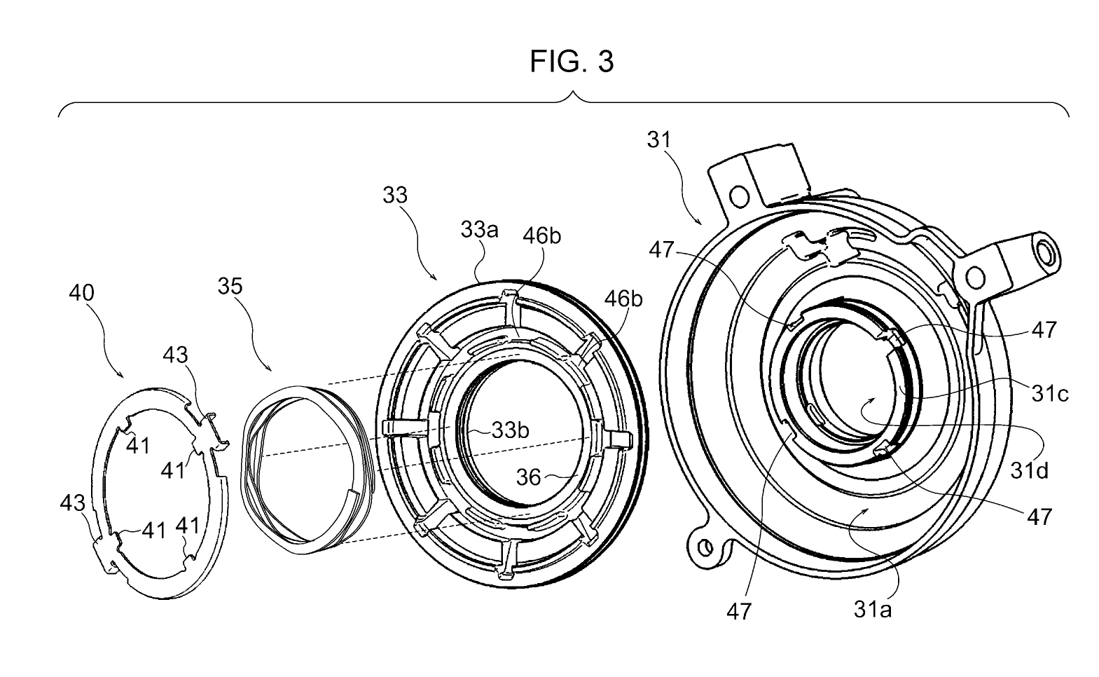

FIG. 2 is a partially enlarged sectional view of a detailed structure of the clutch 20 and its surroundings (portion II in FIG. 1). FIG. 3 is an exploded perspective view of a piston housing 31, a cylinder piston 33, a wave spring 35, and a spring guide 40.

As illustrated in FIG. 2 and FIG. 3, the cylinder piston 33 disposed opposite the opening 21a of the clutch housing 21 is housed in the piston housing 31. The piston housing 31 has a substantially circular opening 31d at its center portion (see FIG. 3). Around the opening 31d, a cylindrical flanged portion 31c protrudes toward the clutch 20 in the axial direction.

On the outer side of the flanged portion 31c in the radial direction, an accommodating portion 31a is disposed to hold the cylinder piston 33. The accommodating portion 31a is an annular recess, in which the surface of the piston housing 31 facing the frictional engagement portion 23 is set back in the axial direction. The cylinder piston 33 is a plate-shaped member having an annular contour and disposed in the accommodating portion 31a. Between the cylinder piston 33 and the end plate 24, a thrust needle bearing 29 is interposed, so that the cylinder piston 33 and the end plate 24 are rotatable relative to each other and integrally movable in the axial direction.

The inner surface of the accommodating portion 31a of the piston housing 31 and the cylinder piston 33 define a piston chamber 32 that allows the working fluid (working oil) to generate a hydraulic pressure. Although not illustrated, an oil passage through which the working oil is introduced from an oil pump (not illustrated) is connected to the piston chamber 32.

The cylinder piston 33 is disposed to be movable in the axial direction inside the accommodating portion 31a of the piston housing 31. An O-ring 34a, serving as an outer-diameter seal member, is disposed in a gap between an outer peripheral edge 33a of the cylinder piston 33 and an inner peripheral surface of the accommodating portion 31a of the piston housing 31 facing the outer peripheral edge 33a to seal the gap. An O-ring 34b, serving as an inner-diameter seal member, is disposed in a gap between an inner peripheral edge 33b of the cylinder piston 33 and an outer peripheral surface of the accommodating portion 31a of the piston housing 31 facing the inner peripheral edge 33b to seal the gap.

The wave spring 35 is disposed on the side of the cylinder piston 33 facing the clutch 20. The wave spring 35 serves as an urging member that urges the cylinder piston 33 in a direction away from the frictional engagement portion 23 against the hydraulic pressure of the piston chamber 32. The wave spring 35 has its end (rear end) in contact with the contact portion 36 at the inner peripheral edge 33b of the cylinder piston 33, on the surface facing away from the piston chamber 32.

The contact portion 36 is a substantially annular belt-shaped portion surrounding the entirety of the inner peripheral edge 33b of the cylinder piston 33. The contact portion 36 is processed to reduce the circumferential frictional resistance against the wave spring 35. In the present embodiment, the surface of the contact portion 36 is coated with a coating having a low coefficient of friction. Specifically, the coating with which the surface of the contact portion 36 is coated is made of a material having a coefficient of friction lower than that of the material of the contact portion 36. For example, the contact portion 36 may be coated with a manganese phosphate coating, which is a material having a coefficient of friction lower than that of the material of the contact portion 36.

The wave spring 35 has its another end (front end) fixed (held) on the piston housing 31 with a spring guide 40, which is a metal-made annular plate member. The spring guide 40 is fastened to the flanged portion 31c of the piston housing 31 using a circlip 38. The spring guide 40 is also fastened to the cylinder piston 33. In this structure, the contact portion 36 of the cylinder piston 33 is pressed (urged) by the urging force (elastic force) of the wave spring 35 in the direction away from the frictional engagement portion 23 in the axial direction.

A bearing 61 is interposed between the flanged portion 31c of the piston housing 31 and a tube-shaped portion 22a of the clutch hub 22. At a position aligned with the bearing 61 in the axial direction, an oil seal 62 is disposed to seal the gap between the second rotating shaft 52 and a radially inner end of the piston housing 31. The bearing 61 and the oil seal 62 are disposed on the inner side of the cylinder piston 33 in the radial direction.

As illustrated in FIG. 3, the piston housing 31, the cylinder piston 33, the wave spring 35, and the spring guide 40 are coaxially arranged and integrally assembled together. Inner hooks 41 of the spring guide 40 are fastened to fastening portions 47 disposed at the flanged portion 31c of the piston housing 31, so that the spring guide 40 is prevented from rotating relative to the piston housing 31. Outer hooks 43 of the spring guide 40 are fastened to recesses 46b of the cylinder piston 33, so that the spring guide 40 is prevented from rotating relative to the cylinder piston 33. These hooks prevent the cylinder piston 33 from rotating relative to the piston housing 31.

In the clutch 20 having the above structure, when the working oil is introduced into the piston chamber 32 in the piston housing 31 with an operation of an oil pump, the cylinder piston 33 that has received pressure from the piston chamber 32 moves toward the clutch 20 in the axial direction. Thus, the cylinder piston 33 presses the end plate 24, and the pressure plates 23a and the friction plates 23b are fastened together so that the clutch 20 engages. When, on the other hand, the working oil is ejected from the piston chamber 32, the cylinder piston 33 is moved by the urging force of the wave spring 35 in the direction away from the clutch 20 in the axial direction. Thus, the pressing force toward the pressure plates 23a and the friction plates 23b is reduced so that the clutch 20 disengages.

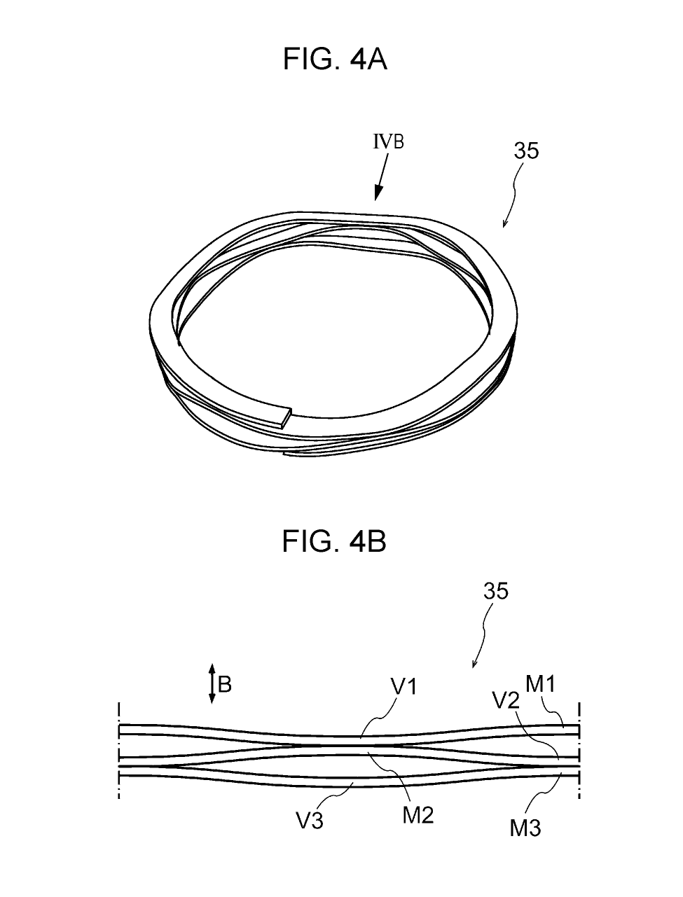

FIGS. 4A and 4B illustrate the wave spring 35, where FIG. 4A is a perspective view of the wave spring 35, and FIG. 4B is a side view of the wave spring 35, viewed in direction IVB in FIG. 4A. As illustrated in FIG. 4A, the wave spring 35 according to the present embodiment is an example having three windings. The wave spring 35 is a plate-shaped urging member having a wavily bent surface. The wave spring 35 has mountain and valley bends arranged so that the angular positions of bends adjacent in the stack direction (direction B) are aligned with each other.

For example, as illustrated in FIG. 4B, the angular positions of a first valley bend V1 and a second mountain bend M2, adjacent to the first valley bend V1 in the stack direction, are aligned with each other, and the angular positions of the second mountain bend M2 and a third valley bend V3, adjacent to the second mountain bend M2 in the stack direction, are aligned with each other. The angular positions of a first mountain bend M1 and a second valley bend V2, adjacent to the first mountain bend M1 in the stack direction, are aligned with each other. The angular positions of the second valley bend V2 and a third mountain bend M3, adjacent to the second valley bend V2 in the stack direction, are aligned with each other.

The power transmission system 1 according to the present embodiment having the above structure includes the wave spring 35 as an urging member that urges the cylinder piston 33 in a direction away from the frictional engagement portion 23. The contact portion 36 of the cylinder piston 33 with which the wave spring 35 comes into contact is processed so as to reduce the friction in the circumferential direction between itself and the wave spring 35.

Thus, the surface of the contact portion 36 slides relative to the wave spring 35 even with the cylinder piston 33 being slightly rotated when pressing the frictional engagement portion 23. This structure prevents the rotation of the cylinder piston 33 from being transmitted to the wave spring 35 formed by multiple windings, and prevents the misalignment of the angular positions of adjacent windings in the wave spring 35. This structure can thus prevent the angular positions of adjacent mountain and valley bends of the wave spring 35 from being misaligned with each other, so that the wave spring 35 can fully exert its elastic force. This structure can thus prevent the misalignment of the angular positions of the wave spring 35 and reliably operate the clutch.

Also in the present embodiment, the contact portion 36 is coated with a coating having a low coefficient of friction. Coating the contact portion 36 with a coating having a low coefficient of friction can reduce the friction between the contact portion 36 and the wave spring 35.

In the present embodiment, the contact portion 36 may be coated with a manganese phosphate coating. Coating the contact portion 36 with a manganese phosphate coating having a low coefficient of friction is advantageous in reducing the friction between the contact portion 36 and the wave spring 35.

Although an embodiment of the present disclosure has been described above, the disclosure is not limited to the above embodiment and may be modified in various manners within the scope of claims, and the scope of technical ideas described in the description and the drawings. A measure to reduce the frictional resistance of the surface of the contact portion 36 is not limited to coating of the surface of the contact portion with a coating. The coating on the surface of the contact portion 36 is not limited to a manganese phosphate coating.

A power transmission system according to an aspect includes a rotating shaft (for example, a first rotating shaft 51 and a second rotating shaft 52 according to an embodiment), a power transmission component (for example, a clutch 20 according to an embodiment) including a frictional engagement portion (23) formed by alternately stacking multiple friction members (for example, pressure plates 23a and friction plates 23b according to an embodiment) in the axial direction at the outer circumference of the rotating shaft, a pressing member (for example, a cylinder piston 33 according to an embodiment) disposed to be movable in the axial direction and pressing the frictional engagement portion to engage the multiple friction members to each other, and an urging member (for example, a wave spring 35 according to an embodiment) that urges the pressing member in a direction away from the frictional engagement portion. The urging member is a wave spring formed with multiple windings. A contact portion (36) of the pressing member with which the wave spring comes into contact is processed so as to reduce the friction in the circumferential direction of the wave spring.

When the contact portion of the pressing member with which the wave spring comes into contact is processed to reduce the friction in the circumferential direction of the wave spring, the surface of the contact portion slides relative to the wave spring even with the pressing member being slightly rotated when pressing the frictional engagement portion. This structure prevents the rotation of the pressing member from being transmitted to the wave spring, and prevents the misalignment of the angular positions of adjacent bends in the wave spring formed by multiple windings. This structure can thus prevent the angular positions of adjacent mountain and valley bends of the wave spring from being misaligned with each other, so that the wave spring can fully exert its elastic force. This structure can thus prevent the misalignment of the angular positions of the wave spring and reliably operate the clutch.

In the above power transmission system, the contact portion may be coated with a coating having a low coefficient of friction. The contact portion coated with a coating having a low coefficient of friction can reduce the friction caused between itself and the wave spring.

In the above power transmission system, the contact portion may be coated with a manganese phosphate coating. Coating the contact portion with a manganese phosphate coating having a low coefficient of friction is preferable to reduce the friction between the contact portion and the wave spring.

The reference signs in the parentheses denote the sings of the corresponding components in an embodiment described below as an example.

The power transmission system according to an aspect is capable of preventing angular misalignment in the wave spring and reliably operating the clutch.

Obviously, numerous modifications and variations of the present invention are possible in light of the above teachings. It is therefore to be understood that within the scope of the appended claims, the invention may be practiced otherwise than as specifically described herein.

What is claimed is:

1. A power transmission system comprising:
a rotating shaft;
a power transmission component including a frictional engagement portion, disposed at an outer circumference of the rotating shaft and formed by alternately stacking a plurality of friction members in an axial direction;
a pressing member disposed to be movable in the axial direction and pressing the frictional engagement portion to engage the plurality of friction members to each other; and
an urging member that urges the pressing member in a direction away from the frictional engagement portion,
wherein the urging member is a wave spring formed with a plurality of windings, and
wherein the pressing member has a contact portion with which the wave spring comes into contact and that is processed so as to reduce a friction in a circumferential direction between the contact portion and the wave spring.

2. The power transmission system according to claim 1, wherein the contact portion is coated with a coating having a low coefficient of friction.

3. The power transmission system according to claim 1, wherein the contact portion is coated with a manganese phosphate coating.

4. A power transmission system comprising:
a rotating shaft rotatable about a rotating axis;
a power transmission component including a frictional engagement portion that includes a plurality of friction members alternately stacked in an axial direction along the rotating axis;
a pressing member having a contact portion and disposed to be movable in the axial direction to press the frictional engagement portion such that the plurality of friction members engage with each other; and
a wave spring to press the pressing member at the contact portion in the axial direction away from the frictional engagement portion, the contact portion of the pressing member having a reduced friction between the contact portion and the wave spring along a circumference of the wave spring.

5. The power transmission system according to claim 4, wherein the contact portion is defined by a coating having a lower coefficient of friction than the pressing member except for the coating.

6. The power transmission system according to claim 4, wherein the contact portion is defined by a manganese phosphate coating.

7. The power transmission system according to claim 4, wherein the frictional engagement portion is disposed at an outer circumference of the rotating shaft about the rotating axis.

8. The power transmission system according to claim 4, wherein the wave spring is defined by a plurality of windings.

9. The power transmission system according to claim 4, wherein a coefficient of friction between the wave spring and the contact portion along the circumference of the wave spring is lower than a coefficient of friction between the wave spring and the pressing member except for the contact portion along the circumference of the wave spring.

10. The power transmission system according to claim 4, wherein a center of the pressing member and a center of the wave spring substantially coincide with the rotating axis when viewed in the axial direction.

11. The power transmission system according to claim 4,
wherein the plurality of friction members include a first friction member and a second friction member, the first friction member connecting to the rotation shaft to rotate with the rotation shaft about the rotating axis, the second friction member not connecting to the rotation shaft, and wherein the power transmission component is configured to transmit power from the first friction member to the second friction member when the rotation shaft rotates and the first friction member and the second friction member engage with each other.
